(19) United States
(12) Patent Application Publication
(10) Pub. No.: US 2026/0230861 A1
(43) Pub. Date: Aug. 6, 2026

(54) PERFORMANCE MANAGEMENT MICROSERVICE SCHEMA CONTROL

(71) Applicant: Rakuten Symphony, Inc., Tokyo (JP)

(72) Inventors: Virendra REDDY, Bangalore (IN); Prasaanth GOWRAVALLI, Bangalore (IN)

(21) Appl. No.: 19/041,996

(22) Filed: Jan. 31, 2025

(51) Int. Cl. H04W 24/08; G06F 9/54

(52) U.S. Cl. CPC H04W 24/08; G06F 9/547; G06F 2209/544

(57) ABSTRACT

A method includes receiving, from a first client microservice of a CNF, a first table identifier, a first plurality of statistic identifiers, and a first plurality of performance statistics. The first table identifier corresponds to a first performance statistics table of the first client microservice, and each statistic identifier of the first plurality of statistic identifiers corresponds to the first table identifier and to a performance statistic of the first plurality of performance statistics. A performance management (PM) microservice of the CNF performs a statistical aggregation process by obtaining a second table identifier and a corresponding second plurality of statistic identifiers defined in a performance management schema of the PM microservice, and includes only performance statistics of the first plurality of performance statistics for which a corresponding statistic identifier matches a statistic identifier of the second plurality of statistic identifiers.

### FIELD

The present disclosure relates to wireless telecommunication networks, and more specifically relates to performance management (PM) microservices for cloud-native network function (CNF) operations, e.g., in radio access network (RAN) applications such as open RAN (O-RAN) applications.

### BACKGROUND

In general, cloud-native network, e.g., RAN and O-RAN, architectures provide large numbers of services and critical applications. Any network, especially a disaggregated, virtualized, multi-vendor system with many large players, can benefit from the gathering of performance information that can be used to address existing issues and improve future performance.

In a cloud-native RAN (virtualized RAN or vRAN) or other network, software may be disaggregated and often runs on off-the-shelf hardware, and in an Open RAN or other open network, software can come from many different vendors. In a cloud-native approach in which network operations are based on cloud-native network functions (CNFs), the software is containerized with baseband software divided into containerized microservices: PHY, RLC, MAC, transport, and other functions. These microservices are typically orchestrated in a Kubernetes cluster and must securely communicate with each other to function reliably. The communication may be managed by a cloud-native entity called “service mesh” including two parts: (1) the control plane that sets up the communication channels between the microservices, and (2) the data plane that manages the transfer of actual data. The microservices are heterogeneous and highly distributed, and can run on multiple different servers that are geographically and logically separated and might be supplied by different vendors, each providing different baseband functions.

### SUMMARY

In some embodiments, a method includes receiving, from a first client microservice of a CNF, a first table identifier, a first plurality of statistic identifiers, and a first plurality of performance statistics, wherein the first table identifier corresponds to a first performance statistics table of the first client microservice, and each statistic identifier of the first plurality of statistic identifiers corresponds to the first table identifier and to a performance statistic of the first plurality of performance statistics, and using a PM microservice of the CNF to perform a statistical aggregation process by obtaining a second table identifier and a corresponding second plurality of statistic identifiers defined in a performance management schema of the PM microservice, and including only performance statistics of the first plurality of performance statistics for which a corresponding statistic identifier matches a statistic identifier of the second plurality of statistic identifiers.

In some embodiments, a method includes using a microservice of a CNF to obtain a first table identifier and a first plurality of statistic identifiers defined in a performance management schema of the microservice, retrieve, from a first performance statistics table corresponding to the first table identifier, a first plurality of performance statistics, wherein each performance statistic of the first plurality of performance statistics corresponds to a statistic identifier of the first plurality of statistic identifiers, and send each of the first table identifier, the first plurality of statistic identifiers, and the first plurality of performance statistics to a PM microservice of the CNF.

In some embodiments, a method includes outputting, from a first client microservice of a CNF, a first table identifier, a first plurality of statistic identifiers, and a first plurality of performance statistics, wherein the first table identifier corresponds to a first performance statistics table of the first client microservice, each statistic identifier of the first plurality of statistic identifiers corresponds to the first table identifier and to a performance statistic of the first plurality of performance statistics, and the first table identifier and the first plurality of statistic identifiers are defined in a first performance management schema of the first client microservice, receiving the first table identifier, first plurality of statistic identifiers, and first plurality of performance statistics at a PM microservice of the CNF, and performing, using the PM microservice, a statistical aggregation process on the first plurality of performance statistics by including only performance statistics of the first plurality of performance statistics for which a corresponding statistic identifier matches a statistic identifier of a second plurality of statistic identifiers defined in a second performance management schema of the PM microservice.

### BRIEF DESCRIPTION OF DRAWINGS

Features, aspects, and advantages of embodiments of the disclosure will be described below with reference to the accompanying drawings, in which like reference numerals denote like elements, and wherein:

FIGS. 1A and 1B are diagrams of a communication system, in accordance with some embodiments.

FIG. 2 is a flowchart of a performance statistics management method, in accordance with some embodiments.

FIG. 3 is a diagram of a performance statistics table, in accordance with some embodiments.

FIG. 4 a diagram of a performance statistics management method, in accordance with some embodiments.

FIG. 5 is a diagram of example components of a device, in accordance with some embodiments.

### DETAILED DESCRIPTION

The following detailed description of example embodiments refers to the accompanying drawings. The present disclosure provides illustrations and descriptions, but is not intended to be exhaustive or to limit the implementations to the precise form disclosed. Modifications and variations are possible in light of the present disclosure or may be acquired from practice of the implementations. Further, one or more features or components of one embodiment may be incorporated into or combined with another embodiment (or one or more features of another embodiment). Additionally, the flowchart and description of operations provided below relate to at least one of the embodiments in the present disclosure. It should be noted that it is possible to make other embodiments that do not exactly match the flowchart and its description. It is understood that in other embodiments one or more operations may be omitted, one or more operations may be added, one or more operations may be performed simultaneously (at least in part).

It will be apparent that systems and/or methods, described herein, may be implemented in different forms of hardware, software, or a combination of hardware and software. The actual specialized control hardware or software code used to implement these systems and/or methods should not limit their implementations. Thus, the operation and behavior of the systems and/or methods are described herein without reference to specific software code. It is understood that software and hardware may be designed to implement the systems and/or methods based on the description herein.

Even though particular combinations of features are recited in the claims and/or disclosed in the specification, the particular combinations are not intended to limit the disclosure of implementations. In fact, many of these features may be combined in ways not specifically recited in the claims and/or disclosed in the specification. Even if a dependent claim directly depends on only one claim, the present disclosure may indicate that the dependent claim is dependent on other claims in the claim set.

No element, act, or instruction used herein should be construed as critical or essential unless explicitly described as such. Also, as used herein, the articles “a” and “an” (in other words, nouns not mentioned in the plural) are intended to include one or more items, and may be used interchangeably with “one or more.” Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B],” “[A] and/or [B],” or “at least one of [A] or [B]” are to be understood as including only A, only B, or both A and B.

In various embodiments, a method and computer readable medium are directed to controlling table and performance statistic identifiers defined in performance management (PM) schema used by cloud-native network function (CNF) microservices to manage performance statistics. A client microservice of the CNF sends a table identifier and one or more statistic identifiers and corresponding performance statistics from a statistics table to a PM microservice of the CNF. In some embodiments, the table and statistic identifiers include or are associated with status markers representative of an active, e.g., preexisting or newly added, or inactive, e.g., obsolete, status of the corresponding table or performance statistic.

The PM microservice receives the table identifier and one or more statistic identifiers and corresponding performance statistics and performs a statistical aggregation process on the one or more performance statistics based on the table identifier, one or more statistic identifiers, and status markers if applicable. The aggregation process includes only the performance statistics of the one or more performance statistics for which a corresponding statistic identifier matches a statistic identifier of a plurality of statistic identifiers defined in the PM schema of the PM microservice, and in some embodiments excludes at least one of the one or more performance statistics based on a status marker. In some embodiments, performing the aggregation process includes assigning a default value to a performance statistic corresponding to a statistic identifier of the plurality of statistic identifiers of the PM microservice that does not match a statistic identifier sent by the client microservice.

A CNF is thereby configured to collect and process performance statistics in situations in which the sets of performance statistics of the client and PM microservices are mismatched, e.g., during a rolling upgrade process in which the PM schema of one of the client or PM microservices has been updated to a newer version than the PM schema of the other of the client or PM microservices. Compared to other approaches, performance statistics are not lost by being ignored based on microservice PM schema version mismatches, and statistical aggregation errors based on mismatched sets of performance statistics are avoided.

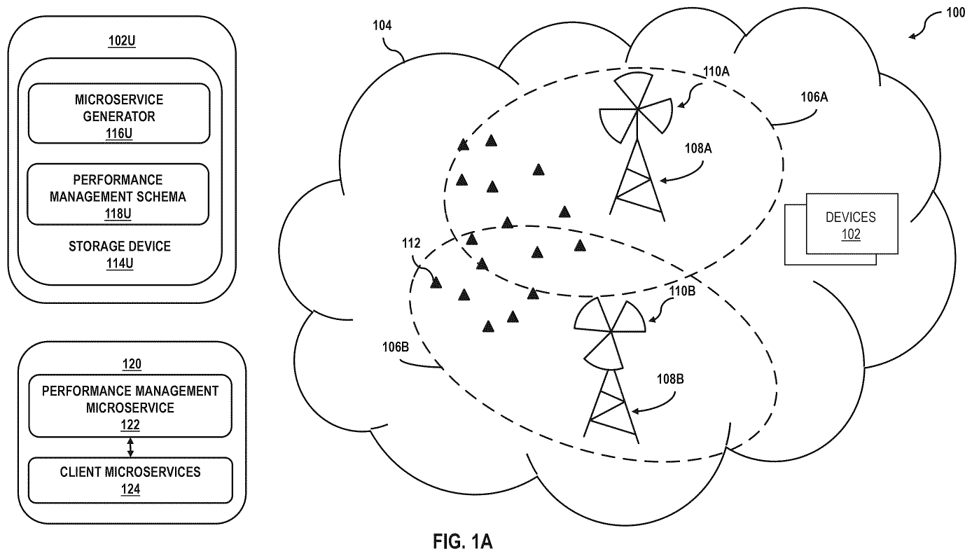

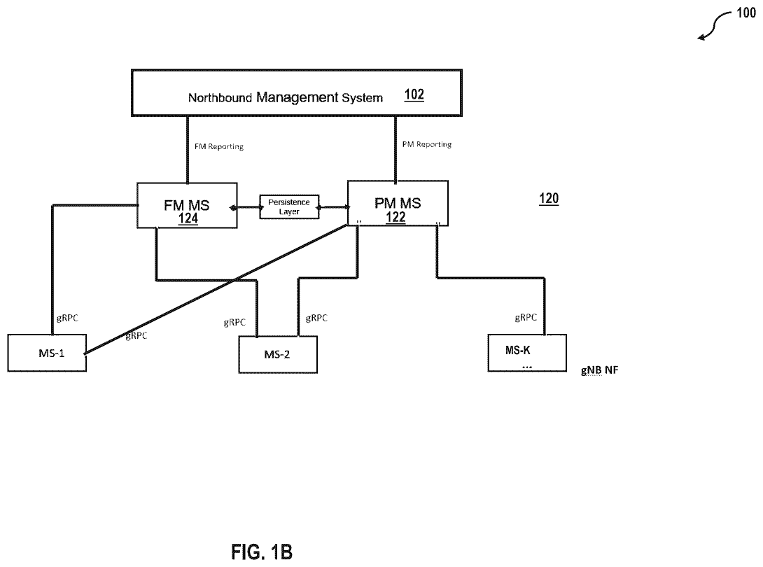

FIG. 1A is a diagram of a networking system 100 (hereinafter referred to as “system 100”), in accordance with some embodiments, and FIG. 1B is a diagram of a portion of system 100, in accordance with some embodiments. Each of FIGS. 1A and 1B is simplified for the purpose of illustration.

System 100 includes a plurality of interconnected devices 102 configured as some or all of a network 104. In various embodiments, devices 102 correspond to combinations of computing devices, computing systems, servers, server clusters, and/or pluralities of server clusters also referred to as server farms or data centers in some embodiments. The combination of interconnected devices 102 includes processing circuitry configured to be usable to perform some or all of the various operations discussed herein.

In some embodiments, one or more of devices 102 are virtualized network components, e.g., virtualized network functions (VNFs) such as cloud-native network functions (CNFs), including software configured to implement one or more network functions by running on one or more hardware devices. In some embodiments, some or all of devices 102 are configured as some or all of a network function virtualization infrastructure (NFVI). Other configurations and/or types of devices 102 are within the scope of the present disclosure.

FIG. 1A depicts an instance of devices 102, a device 102U, and a CNF 120, each of which is further discussed below.

In some embodiments, network 104 includes one or more radio access networks (RANs) or a portion of a RAN. In some embodiments, a RAN is a mobile telecommunication system that implements a radio access technology (RAT) and resides between instances of user equipment (UE) 112, e.g., mobile phones, computers, or the like, and provides connection with devices 102. In some embodiments, a RAN is an open RAN (O-RAN).

In some embodiments, one or more of devices 102 are configured to perform management functions corresponding to network 104. In various embodiments, one or more of devices 102 are configured as one or more of an operations support system (OSS), an element management system (EMS), a network management system (NMS), an access and mobility management function (AMF), or other system or function configured to perform one or more activities supporting operations of network 104.

In some embodiments, one or more of the interconnected devices 102 of network 104 are configured as one or more of a local area network (LAN), a wide area network (WAN), a metropolitan area network (MAN), an internet area network (IAN), a campus area network (CAN), or a virtual private network (VPN). In some embodiments, one or more of the interconnected devices 102 of network 104 are configured as a backbone or core network (CN), a part of a computer network that interconnects networks, providing a path for the exchange of information between different LANs, WANs, etc.

In some embodiments, some of the interconnected devices 102 of network 104 are configured as server clusters, e.g., included in a data center. In some embodiments, the server clusters are part of a cloud computing environment.

In some embodiments, network 104 is some or all of a global system for mobile communications (GSM) RAN, a GSM/EDGE RAN, a universal mobile telecommunications system (UMTS) RAN (UTRAN), an evolved universal terrestrial radio access network (E-UTRAN), open RAN (O-RAN), or cloud-RAN (C-RAN). In some embodiments, network 104 resides between a UE 112 and one or more core networks of system 100.

In some embodiments, network 104 is some or all of a hierarchical telecommunications network, e.g., system 100, including one or more intermediate link(s), also referred to as backhaul portions in some embodiments, between a RAN and one or more core networks. Non-limiting examples of mobile backhaul implementations include fiber-based backhaul, wireless point-to-point backhaul, copper-based wireline, satellite communications, and point-to-multipoint wireless technologies. In some embodiments, backhaul refers to the side of the network that communicates with the global internet.

In the embodiment depicted in FIG. 1A, network 104 includes cells 106A and 106B, which include respective base stations 108A and 108B and respective antennas 110A and 110B. In some embodiments, network 104 includes a plurality of cells including cells 106A and 106B and collectively referred to as cells 106 or, in some embodiments coverage areas 106, a plurality of base stations including base stations 108A and 108B and collectively referred to as base stations 108, and a plurality of antennas including antennas 110A and 110B and collectively referred to as antennas 110.

In the embodiment depicted in FIG. 1A, a single base station 108 corresponds to single instances of each of cells 106 and antennas 110. In various embodiments, a single base station 108 corresponds to more than one instance of cells 106 and/or more than one instance of antennas 110.

In some embodiments, base stations 108 are lattice or self-supported towers, guyed towers, monopole towers, and concealed towers (e.g., towers designed to resemble trees, cacti, water towers, signs, light standards, and other types of structures). In some embodiments, a base station 108 is a cellular-enabled mobile device site where antennas and electronic communications equipment are placed, typically on a radio mast, tower, or other raised structure to create a cell 106 (or adjacent cells) in a network. The raised structure typically supports antenna(s) 110 and one or more sets of transmitter/receivers, transceivers, digital signal processors, control electronics, a remote radio head (RRH), primary and backup electrical power sources, and sheltering. Base stations 108 are known by other names such as base transceiver station, mobile phone mast, or cell tower. In some embodiments, base stations 108 are edge devices configured to wirelessly communicate with UEs 112. The edge device provides an entry point into service provider core networks. Examples include routers, routing switches, integrated access devices (IADs), multiplexers, and a variety of MAN and WAN access devices.

In at least one embodiment, an instance of antenna 110 is a sector antenna, e.g., a directional microwave antenna with a sector-shaped radiation pattern, or a plurality of sector antennae, e.g., configured to have a full-circle coverage area 106. In some embodiments, an instance of antenna 110 is a circular antenna. In some embodiments, an instance of antenna 110 operates at one or more microwave or ultra-high frequency (UHF) frequencies, e.g., ranging from 300 Megahertz (MHz) to 7.2 Gigahertz (GHz). In some embodiments, an instance of antenna 110 operates at one or more frequencies ranging from 24.2 GHz to 71.0 GHz.

In various embodiments, a cell 106 is a three-dimensional space having a shape and size based on the configurations of the corresponding base station 108, e.g., a power level, and antenna 110, e.g., a number of sectors. In various embodiments, a cell 106 has a substantially spherical, hemispherical, conical, columnar, circular or oval disc, or other shape corresponding to a base station and antenna configuration. In various embodiments, one or both of the shape or size of a cell 106 varies over time, e.g., based on a variable base station power level and/or a variable number of activated antennae and/or antenna sectors. In some embodiments, a cell 106 is referred to as a macro-cell, a micro-cell, a pico-cell, a femto-cell, or a small cell. In some embodiments, a cell 106 is referred to as an indoor small cell (IDSC).

In some embodiments, an instance of UE 112 is a computer or computing system. In some embodiments, an instance of UE 112 has a liquid crystal display (LCD), light-emitting diode (LED) or organic light-emitting diode (OLED) screen interface, such as a graphical user interface providing a touchscreen interface with digital buttons and keyboard or physical buttons along with a physical keyboard. In some embodiments, an instance of UE 112 connects to the internet and interconnects with other devices. In some embodiments, an instance of UE 112 incorporates integrated cameras, the ability to place and receive voice and video telephone calls, video games, and Global Positioning System (GPS) capabilities. In some embodiments, an instance of UE 112 performs as a virtual machine or allows third-party apps to run as a container. In some embodiments, an instance of UE 112 is a computer (such as a tablet computer, netbook, digital media player, digital assistant, graphing calculator, handheld game console, handheld personal computer (PC), laptop, mobile internet device (MID), personal digital assistant (PDA), pocket calculator, portable medial player, or ultra-mobile PC), a mobile phone (such as a camera phone, feature phone, smartphone, or phablet), a digital camera (such as a digital camcorder, or digital still camera (DSC), digital video camera (DVC), or front-facing camera), a pager, a personal navigation device (PND), a wearable computer (such as a calculator watch, smartwatch, head-mounted display, earphones, or biometric device), or a smart card.

A UE 112 is configured to communicate with base stations 108 via signals transmitted to and from antennas 110.

Network 104 includes a plurality of network nodes, referred to as nodes or RAN nodes in some embodiments. In some embodiments, a node corresponds to one or more devices 102, a combination of one or more devices 102 and one or more base stations 108, or one or more base stations 108. In some embodiments, a node corresponds to a base station 108 that is an instance of devices 102.

In some embodiments, a node corresponds to a device 102 configured as a centralized unit (CU) and one or more base stations 108 configured as distributed units (DUs) and/or radio units (RUs). In some embodiments, a node is a next generation RAN (NG-RAN) node, e.g., a gNB an NG-eNB according to 3GPP TS 38.300 specifications.

Nodes are interconnected to each other and to network management entities, e.g., an EMS or AMF, through various interfaces. In some embodiments, interfaces between nodes and core network elements are referred to as NG interfaces. In some embodiments, interfaces between various nodes, e.g., NG-RAN nodes, are referred to as Xn interfaces.

In the embodiment depicted in FIG. 1A, device 102U is a device configured to deploy one or more applications to network 104. Device 102U includes a storage device 114U configured to store a microservice generator 116U and PM schema 118U. In the embodiment depicted in FIG. 1A, device 102U is a single instance of devices 102. In some embodiments, device 102U includes more than one instance of devices 102.

A storage device, e.g., storage device 114U, is one or more computer-readable, non-volatile storage media including one or more of dynamic memory (e.g., RAM, magnetic disk, writable optical disk, or the like) and static memory (e.g., ROM, CD-ROM, or the like) configured to store executable instructions that when executed perform the operations described herein to facilitate automated certificate management. In some embodiments, storage device 114U is also configured to store data associated with or generated by the execution of the operations, e.g., PM schema 118U.

In the embodiment depicted in FIG. 1A, storage device 114U is located on device 102U. In some embodiments, storage device 114U is located partially or entirely externally to device 102U, e.g., on one or more servers corresponding to devices 102.

Microservice generator 116U is one or more sets of instructions configured to be executed on device 102U whereby CNF 120 is deployed and/or managed on network 104. PM schema 118U is a set of performance statistic and performance statistics table identifier definitions, hierarchies, and data records configured to be usable by CNF 120 as discussed below with respect to FIGS. 1B-4 and a method 200.

CNF 120 is an application configured to perform one or more networking functions or applications of network 104. In some embodiments, CNF 120 includes a CU CNF or a DU CNF of a RAN or an O-RAN. In some embodiments, CNF 120 includes a non-limiting example RAN node gNB discussed below with respect to FIG. 1B. In some embodiments, CNF 120 is an application of a network other than a RAN or O-RAN.

CNF 120 includes a PM microservice 122, also referred to as a PM server microservice 122 in some embodiments, and additional microservices 124, also referred to as client microservices 124 in some embodiments. Each of PM microservice 122 and client microservices 124 includes a set of instructions configured to perform one or more networking functions as a component, e.g., a pod, of CNF 120. In some embodiments, one or more client microservices 124 include RUs configured to communicate with one or more instances of UE 112.

PM microservice 122 and client microservices 124 are configured to, in operation, communicate with each other through one or more application programming interfaces (APIs), e.g., a gRPC/JSON API, corresponding to a communications architecture, e.g., a remote procedure call RPC or gRPC) architecture.

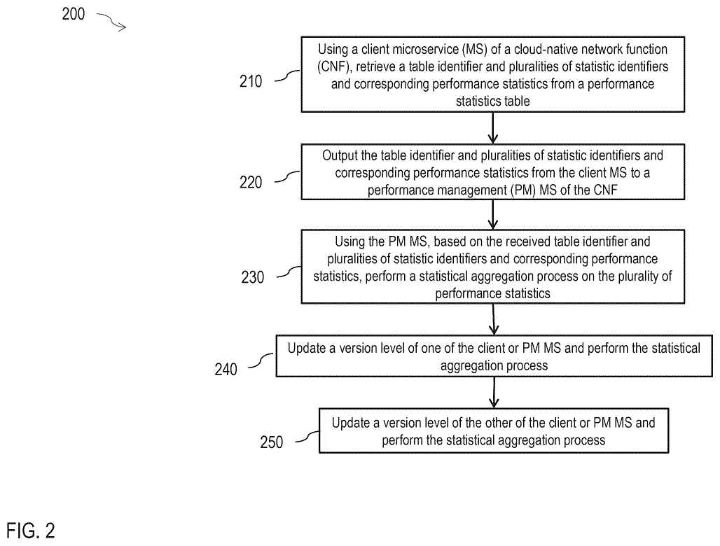

One or more of CNF 120, PM microservice 122, and client microservices 124 are configured to, collectively and/or individually, perform some or all of the operations of method 200 discussed below with respect to FIGS. 2-4.

In the embodiment depicted in FIG. 1B, system 100 includes network 104 configured as a RAN, e.g., an O-RAN, including one or more instances of device 102 configured as a northbound management system (NMS) 102, e.g., including operations support systems (OSS), and an instance of CNF 120 configured as a node gNB NF 120 of the RAN.

NMS is a network entity configured to receive fault management (FM) reporting information and PM reporting information from various CNFs of the RAN including gNB NF 120, store and analyze the information, and in some embodiments initiate one or more network management activities based on the information. In some embodiments NMS includes OSS configured to manage the PM reporting information.

gNB NF 120 includes an instance of client microservice 124, also referred to as an FM microservice (FM MS) 124 in some embodiments, coupled to a PM microservice PM MS through a persistence layer, and a number K of client microservices MS-1-MS-K. PM microservice (PM MS) is a non-limiting example of PM microservice 122 referred to as PM MS 122 in some embodiments, and client microservices MS-1-MS-K are non-limiting examples of client microservices 124.

Each of FM MS 124 and PM MS 122 is configured to send communications to and/or receive communications from some or all of client microservices MS-1-MS-K through gRPC messages. In some embodiments, one or more of client microservices MS-1-MS-K includes a CU, DU, or RU of the RAN.

Client microservices MS-1-MS-K are configured to send fault data to FM MS 124 and performance data to PM MS 122 through gRPC messages. In some embodiments, gNB NF 120 includes one or more microservices (not shown) in addition to client microservices MS-1-MS-K.

The performance data are collected by client microservices MS-1-MS-K as performance statistics grouped in performance statistics tables, sent from client microservices MS-1-MS-K to PM MS 122, aggregated by PM MS122, and sent from PM MS 122 to NMS 102, e.g., as summarized PM reporting information, in accordance with PM schema 118U. In some embodiments, the performance statistics and summarized data include one or more of a throughput number, a number of active cell users, a cell uptime, a cell downtime, or the like.

As a number of performance statistics increases, a potential for inaccurate data aggregation by PM MS 122 increases. In some embodiments PM MS 122 is configured to aggregate a total number of performance statistics ranging from 200 to 1000. In some embodiments PM MS 122 is configured to aggregate a total number of performance statistics ranging from 300 to 500.

As network functions evolve, the number and types of performance statistics collected, aggregated, and reported by CNF 120 change such that different release versions of PM schema 118U define performance statistic and table identifiers that correspond to different combinations of performance statistics and performance statistics tables. PM MS 122 and each instance of client microservices MS-1-MS-K operate at version levels, each version level corresponding to a predetermined release version of PM schema 118U.

During some time periods, PM MS 122 and each instance of client microservices MS-1-MS-K operate at version levels corresponding to a same release version of PM schema 118U. During other time periods, e.g., during rolling upgrades of PM MS 122 and client microservices MS-1-MS-K, PM MS 122 operates at a version level corresponding to a first release version of PM schema 118U, and one or more of client microservices MS-1-MS-K operates at a version level corresponding to a second release version of PM schema 118U earlier or later than the first release version of PM schema 118U.

During such other time periods, potential mismatches therefore exist between the performance statistics that PM MS 122 is configured to aggregate based on the first release version of PM schema 118U and the performance statistics that the one or more of client microservices MS-1-MS-K is configured to send based on the second release version of PM schema 118U.

As further discussed below, each client microservice MS-1-MS-K is thereby configured to collect and store performance statistics in one or more performance statistics tables, each table having a unique, predetermined table identifier defined in the PM schema release version, and each performance statistic being stored in the corresponding table along with a unique, predetermined statistic identifier defined in the PM schema release version. Each client microservice MS-1-MS-K is also configured to send the table identifier, statistic identifiers, and corresponding performance statistics to PM MS 122.

PM MS 122 is configured to receive the table identifiers, statistic identifiers, and corresponding performance statistics from each client microservice MS-1-MS-K, and perform an aggregation process by including only the received performance statistics for which a corresponding table identifier and statistic identifier match a table identifier and statistic identifier of PM MS 122. In some embodiments PM MS 122 is configured to perform the aggregation process by assigning a default value, e.g., a zero value, to a performance statistic corresponding to a statistic identifier of PM MS 122 that is not included in the statistic identifiers received from a given client microservice MS-1-MS-K.

PM schema 118U includes specifications of the table and statistic identifiers such that each release version of PM schema 118U controls the table and statistic identifiers used by PM MS 122 and client microservice MS-1-MS-K as discussed above.

CNF 120 including PM MS 122 and client microservices MS-1-MS-K configured to control performance statistics collection and reporting in accordance with the release versions of PM schema 118U is thereby configured to avoid lost performance statistics and/or statistical aggregation errors based on microservice version mismatches, compared to some other approaches.

System 100 including one or more instances of CNF 120 configured as discussed above so as to perform some or all of method 200 is thereby configured to obtain such benefits as further discussed below with respect to method 200.

FIG. 2 is a flowchart of performance statistics management method 200, in accordance with some embodiments. Performance statistics management method 200, also referred to as a method 200, a method of operating a CNF 200, a method of operating a microservice of a CNF 120, or a method of operating a PM microservice of a CNF 120 in some embodiments, is operable on a networking system, e.g., system 100 discussed above with respect to FIGS. 1A and 1B.

Additional operations may be performed before, during, between, and/or after the operations of method 200 depicted in FIG. 2, and some other operations may only be briefly described herein. In some embodiments, other orders of operations of method 200 are within the scope of the present disclosure. In some embodiments, one or more operations of method 200 are not performed.

In some embodiments, some or all of the operations of method 200 are included in another method, e.g., a method of operating a networking system. In some embodiments, some or all of the operations of method 200 discussed below are repeated, e.g., as part of operating a networking system.

In some embodiments, some or all of the operations of method 200 discussed below are capable of being performed automatically, e.g., by CNF 120 including PM microservice 122 and client microservices 124, each discussed above with respect to FIGS. 1A and 1B. In some embodiments, some of the operations of method 200 are capable of being performed by a single instance of a microservice, e.g., PM microservice 122 or a client microservice 124.

The operations of method 200 are discussed below with reference to various features of system 100 that are also discussed above with respect to FIGS. 1A and 1B.

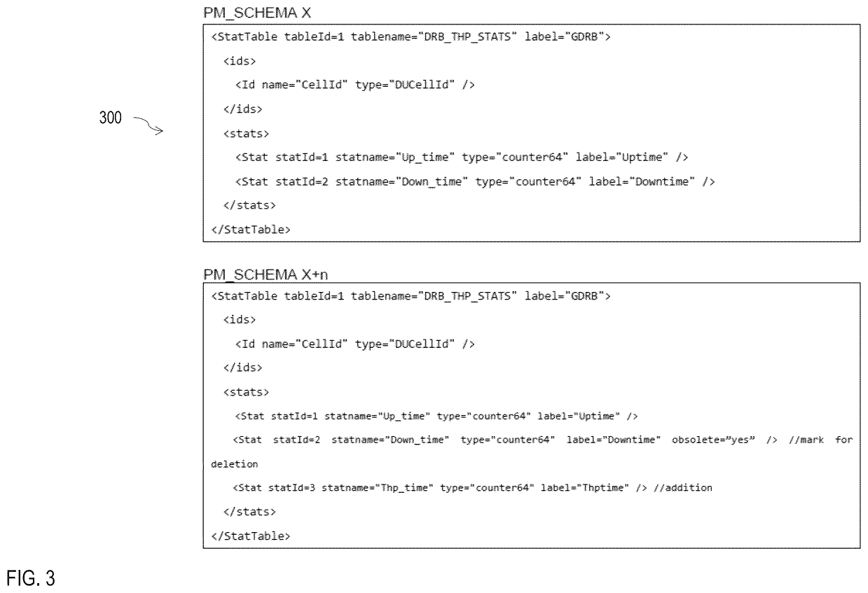

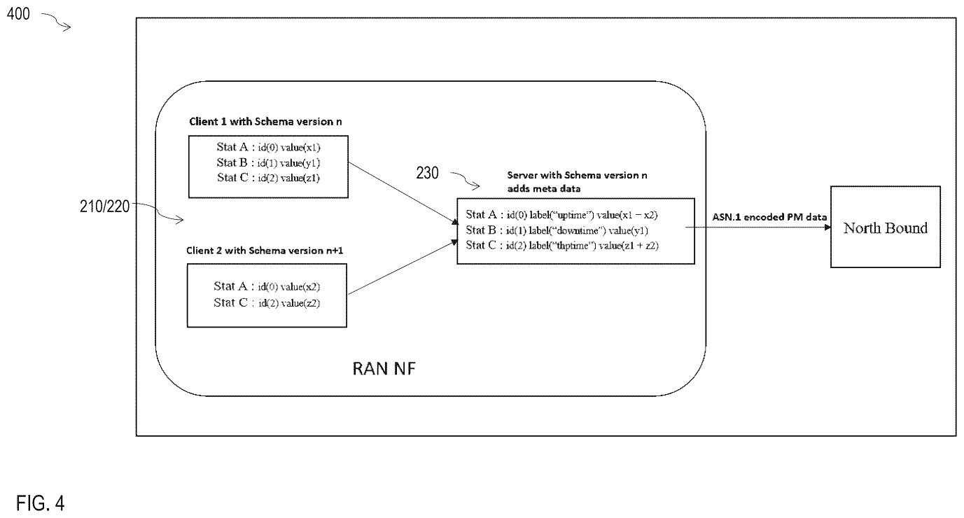

Each of FIGS. 3 and 4 depicts a non-limiting example that illustrates the execution of some or all of the operations of method 200 using embodiments of system 100, as discussed below.

At operation 210, in some embodiments, a client microservice (MS) of a CNF is used to retrieve a table identifier and pluralities of statistic identifiers and corresponding performance statistics from a performance statistics table. The table identifier and performance statistic identifiers are obtained, e.g., through execution of one or more sets of instructions, by being defined in a PM schema of the client MS. In some embodiments, the client MS of the CNF retrieving the identifier and pluralities of statistic identifiers and corresponding performance statistics from the performance statistics table includes an instance of client MS 124, e.g., MS-1-MS-K, of CNF 120 retrieving the identifier and pluralities of statistic identifiers and corresponding performance statistics from the performance statistics table in accordance with PM schema 118U.

In some embodiments, the client MS of the CNF retrieving the identifier and pluralities of statistic identifiers and corresponding performance statistics from the performance statistics table includes retrieving a status marker corresponding to a first statistic identifier and performance statistic, and excluding the first statistic identifier from the plurality of statistic identifiers and the first performance statistic from the plurality of performance statistics in response to a first indication of the status marker, e.g., a Boolean value corresponding to an obsolete or inactive status.

In some embodiments, the client MS of the CNF retrieving the identifier and pluralities of statistic identifiers and corresponding performance statistics from the performance statistics table includes retrieving a status marker corresponding to a second statistic identifier and performance statistic, and including the second statistic identifier in the plurality of statistic identifiers and the second performance statistic in the plurality of performance statistics in response to a second indication of the status marker, e.g., a Boolean value corresponding to an active status.

By including one or more status markers in addition to the statistic identifiers, unintentional reuse of an obsolete statistic identifier can be avoided by retaining the obsolete statistic identifier in a table as PM schema release versions are updated.

In some embodiments, the table identifier is one table identifier of a plurality of table identifiers corresponding to a plurality of tables, and retrieving the table identifier includes retrieving the plurality of table identifiers and corresponding pluralities of statistic identifiers and corresponding performance statistics from each table of the corresponding plurality of tables.

In some embodiments, the client MS is one client MS of a plurality of client MSs, and retrieving the table identifier and pluralities of statistic identifiers and corresponding performance statistics from the performance statistics table includes retrieving one or more table identifiers and corresponding pluralities of statistic identifiers and corresponding performance statistics from each client MS of the plurality of MSs, e.g., client MSs 124 such as MS-1-MS-K.

At operation 220, in some embodiments, the table identifier and pluralities of statistic identifiers and corresponding performance statistics are sent from the client MS to a PM MS of the CNF. In some embodiments, sending the table identifier and pluralities of statistic identifiers and corresponding performance statistics from the client MS to the PM MS of the CNF includes sending the table identifier and pluralities of statistic identifiers and corresponding performance statistics from a client MS 124, e.g., MS-1-MS-K, to PM MS 122 of CNF 120.

In some embodiments, sending the table identifier and pluralities of statistic identifiers and corresponding performance statistics from the client MS to the PM MS includes sending one or more additional table identifiers and corresponding pluralities of statistic identifiers and corresponding performance statistics from the client MS and/or from one or more additional client MSs, e.g., client MS 124 such as MS-1-MS-K, to the PM MS, e.g., PM MS 122.

In some embodiments, sending each of the first table identifier, the first plurality of statistic identifiers, and the first plurality of performance statistics to the PM MS includes sending an RPC message.

At operation 230, in some embodiments, the PM MS receives the table identifier and pluralities of statistic identifiers and corresponding performance statistics and performs a statistical aggregation process on the plurality of performance statistics based on the received table identifier and pluralities of statistic identifiers and corresponding performance statistics. In some embodiments, the PM MS receiving the table identifier and pluralities of statistic identifiers and corresponding performance statistics and performing the statistical aggregation process on the plurality of performance statistics includes PM MS 122 receiving the table identifier and pluralities of statistic identifiers and corresponding performance statistics and performing the statistical aggregation process on the plurality of performance statistics based on the received table identifier and pluralities of statistic identifiers and corresponding performance statistics.

The statistical aggregation process is performed on the received plurality of performance statistics by including only performance statistics of the received plurality of performance statistics for which a corresponding statistic identifier matches a statistic identifier of a plurality of statistic identifiers defined in the PM schema of the PM MS, e.g., PM MS 122.

In some embodiments, including only performance statistics of the received plurality of performance statistics for which the corresponding statistic identifier matches a statistic identifier of the second plurality of statistic identifiers includes excluding a performance statistic of the received plurality of performance statistics based on a status marker of the plurality of statistic identifiers of the PM MS, e.g., a Boolean value corresponding to an obsolete or inactive status.

In some embodiments, performing the statistical aggregation process on the plurality of performance statistics includes assigning a default value to a performance statistic corresponding to a statistic identifier of the received plurality of statistic identifiers that is not included in the plurality of statistic identifiers of the PM MS, e.g., PM MS 122.

In some embodiments, performing the statistical aggregation process on the plurality of performance statistics includes sending statistical summary information to an NMS or OSS, e.g., NMS 102, in which the summary information includes each of the included performance statistics of the received plurality of performance statistics. In some embodiments, sending the statistical summary information includes sending the statistical summary information including a performance statistic corresponding to a statistic identifier of the plurality of statistic identifiers of the PM MS and not included in the received plurality of performance statistics.

In some embodiments, sending the statistical summary information includes sending the statistical summary information at predetermined intervals, e.g., every minute or 15 minutes.

In some embodiments, receiving the table identifier and pluralities of statistic identifiers and corresponding performance statistics from the client MS includes receiving one or more additional table identifiers and corresponding pluralities of statistic identifiers and corresponding performance statistics from the client MS and/or from one or more additional client MSs, e.g., client MS 124 such as MS-1-MS-K, and performing the statistical aggregation process includes performing the statistical aggregation process based on each of the received table identifiers and corresponding pluralities of statistic identifiers and corresponding performance statistics.

At operation 240, in some embodiments, a version level of the PM schema of one of the client or PM MS is updated and the statistical aggregation process is performed based on the updated PM schema version level. In some embodiments, updating a PM schema version of a client or PM MS includes updating versions of some or all of one or more sets of instructions of the client or PM MS. In some embodiments, updating a PM schema version of a client or PM MS includes updating a top-level version of the client or PM MS.

In some embodiments, updating the PM schema version level includes updating a PM schema version level of the client MS, e.g., client MS 124, and outputting, from the updated client MS, the first table identifier, an additional plurality of statistic identifiers, and an additional plurality of performance statistics, and each statistic identifier of the additional plurality of statistic identifiers corresponds to a predetermined performance statistic of the second plurality of performance statistics.

In some embodiments, updating the version level includes updating a version level of the PM schema of the PM MS, e.g., PM MS 122, and performing the statistical aggregation process includes including each performance statistic of the received plurality of performance statistics for which a corresponding statistic identifier matches a statistic identifier of an updated plurality of statistic identifiers of the PM MS.

In some embodiments, updating a PM schema version includes adding and/or changing one or more status markers corresponding to or included in one or more statistic identifiers defined in the PM schema.

At operation 250, in some embodiments, a version level of the PM schema of the other of the client or PM MS is updated and the statistical aggregation process is performed based on the updated version level in the manner discussed above with respect to operation 240.

In some embodiments, one or both of operations 240 or 250 are repeated, e.g., as part of rolling updates to a CNF, e.g., CNF 120.

By performing some or all of the operations of method 200, one or more MSs and/or a CNF are capable of collecting and processing performance statistics in situations in which the sets of performance statistics of the client and PM MSs are mismatched, e.g., during a rolling upgrade process in which one of the client or PM MSs has been updated to a newer PM schema version than the other of the client or PM MSs. Compared to other approaches, performance statistics are not lost by being ignored based on microservice PM schema version mismatches, and statistical aggregation errors based on mismatched sets of performance statistics are avoided.

FIG. 3 is a diagram of a performance statistics table 300, in accordance with some embodiments. Performance statistics table 300 is a non-limiting example of multiple version levels of a performance statistics table as discussed above, and is simplified for the purpose of illustration.

As depicted in FIG. 3, performance statistics table 300 includes a first version level (top) corresponding to a schema release version PM_SCHEMA X and a second version level (bottom) corresponding to a schema release version PM_SCHEMA X+n, each schema release version being a non-limiting example of PM schema 118U discussed above.

Each version of performance statistics table 300 includes a table identifier tableID=1, statistic identifiers statId+1 and statId=2, and corresponding performance statistics Up-time and Down-time. The second version includes status indicator obsolete=“yes” corresponding to performance statistic Down_time and statId=2, and a third statistic identifier statId=3 and corresponding performance statistic Thp_time.

FIG. 4 is a flowchart of a performance statistics management method 400, in accordance with some embodiments. Method 400 corresponds to a non-limiting example of operations 210-230 of method 200 performed on a performance statistics table as depicted in FIG. 4.

In the embodiment depicted in FIG. 4, operations 210 and 220 correspond to an MS client 124, Client 1, at a version level corresponding to schema release version n, retrieving statistic identifiers id(0)-id(2) and corresponding performance statistics Stats A, B, and C from the performance statistics table, and sending them to PM MS 122, Server, at a version level also corresponding to schema release version n. An MS client, Client 2, at a version level corresponding to schema release version n+1, retrieves statistic identifiers id(0) and id(2) and corresponding performance statistics Stats A and C from the performance statistics table and sends them to Server.

Operation 230 corresponds to Server receiving each of the statistic identifiers and corresponding performance statistics from Clients 1 and 2, performing the aggregation operation by including performance statistic values x1, y1, and z1 received from Client 1 and performance statistic values x2 and z2 from Client 2 in corresponding summing operations, and sending the PM data to an NMS North Bound. Based on the statistic identifiers received from Client 2 not including id(1), Server performs the summing operation on StatB based solely on value y1 received from Client 1.

By executing some or all of the operations of method 200 in accordance with the non-limiting example of method 400, the benefits discussed above with respect to FIGS. 1A-2 are capable of being realized.

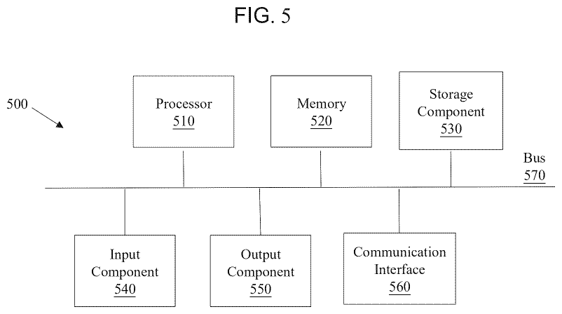

FIG. 5 illustrates an embodiment of a device 500, e.g., device 102 and/or 102U discussed above. As shown in FIG. 5, the device 500 includes processor 510, a memory 520, a storage component 530, an input component 540, an output component 550, a communication interface 560, and a bus 570.

The processor 510, as used herein, means any type of computational circuit that may comprise hardware elements and software elements. The processor 510 may be embodied as a multi-core processor, a single core processor, or a combination of one or more multi-core processors and/or one or more single core processors, a distributed processing system, or the like. The processor 510 may be a Central Processing Unit (CPU), a graphics processing unit (GPU), an accelerated processing unit (APU), an application-specific integrated circuit (ASIC), or another type of processing component.

Memory 520 includes a non-transitory computer readable medium. Memory 520 includes a random-access memory (RAM), a read only memory (ROM), and/or another type of dynamic or static storage device (e.g., a flash memory, a magnetic memory, and/or an optical memory) that stores information and/or instructions for use by processor 510. The memory 520 comprises machine-readable instructions which are executable by the processor 510. These machine-readable instructions when executed by the processor 510 cause the processor 510 to perform one or more method steps of an embodiment described above.

Storage component 530 stores information and/or software related to the operation and use of the device 500. For example, storage component 530 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

Input component 540 is configured to receive information, such as user input. For example, the input component 540 may include, but not be limited to, a touch screen display, a keyboard, a keypad, a mouse, a button, a switch, and/or a microphone. Additionally, or alternatively, the input component 540 may include a sensor for sensing information (e.g., a global positioning system (GPS), an accelerometer, a gyroscope, and/or an actuator).

Output component 550 is configured to provide output information from the device 500. For example, the output component 550 may be, but not limited to, a display, a speaker, an instruction device to an external device, and/or one or more light-emitting diodes (LEDs).

Communication interface 560 is an interface that provides a communication connection to other devices, such as external devices and internal devices. The connection by the communication interface 560 can be a wired connection, a wireless connection, or a combination of wired and wireless connections, and can be a direct connection or an indirect connection via a communication network that exists between the device 500 and other devices. In other words, the standard of the communication interface 560 is not limited.

The bus 570 acts as an interconnect between the processor 510, the memory 520, the storage component 530, the input component 540, the output component 550, and the communication interface 560 of the device 500. The bus 570 may include a wired interconnection or a wireless interconnection.

The number and arrangement of components shown in FIG. 5 are provided as an example. In practice, device 500 may include additional components, fewer components, different components, or differently arranged components than those shown in FIG. 5. Additionally, or alternatively, a set of components (e.g., one or more components) of device 500 may perform one or more functions described as being performed by another set of components of device 500. Further, one or more method steps described in any of the embodiments may be performed utilizing a plurality of devices 500 in communication with one another.

[Item-1] A method includes receiving, from a first client microservice of a CNF, a first table identifier, a first plurality of statistic identifiers, and a first plurality of performance statistics, wherein the first table identifier corresponds to a first performance statistics table of the first client microservice, and each statistic identifier of the first plurality of statistic identifiers corresponds to the first table identifier and to a performance statistic of the first plurality of performance statistics, and using a PM microservice of the CNF to perform a statistical aggregation process by obtaining a second table identifier and a corresponding second plurality of statistic identifiers defined in a performance management schema of the PM microservice, and including only performance statistics of the first plurality of performance statistics for which a corresponding statistic identifier matches a statistic identifier of the second plurality of statistic identifiers.

[Item-2] The method of Item-1, wherein performing the statistical aggregation process includes assigning a default value to a performance statistic corresponding to a statistic identifier of the second plurality of statistic identifiers that is not included in the first plurality of statistic identifiers.

[Item-3] The method of Item-1 or Item-2, wherein the performance statistics of the first plurality of performance statistics matching the corresponding statistic identifier of the second plurality of statistic identifiers is based on a status marker of the corresponding statistic identifier.

[Item-4] The method of any of Item-1-Item-3, wherein performing the statistical aggregation process includes sending statistical summary information to an NMS, and the statistical summary information includes each of the included performance statistics of the first plurality of performance statistics.

[Item-5] The method of any of Item-1-Item-4, wherein the CNF includes a node of a RAN and the first plurality of performance statistics includes one or more of a throughput number, a number of active cell users, a cell uptime, or a cell downtime.

[Item-6] The method of any of Item-1-Item-5, further including receiving, from the first client microservice, a third table identifier, a third plurality of statistic identifiers, and a second plurality of performance statistics, wherein the third table identifier corresponds to a second performance statistics table of the first client microservice and each statistic identifier of the third plurality of statistic identifiers corresponds to the third table identifier and to a performance statistic of the second plurality of performance statistics, and performing the statistical aggregation process further by obtaining a fourth table identifier and a corresponding fourth plurality of statistic identifiers defined in the performance management schema of the PM microservice; and including only performance statistics of the second plurality of performance statistics for which a corresponding statistic identifier matches a statistic identifier of the fourth plurality of statistic identifiers.

[Item-7] The method of any of Item-1-Item-6, further including receiving, from a second client microservice of the CNF, a third table identifier, a third plurality of statistic identifiers, and a second plurality of performance statistics, wherein the second table identifier corresponds to a first performance statistics table of the second client microservice and each statistic identifier of the third plurality of statistic identifiers corresponds to the third table identifier and to a performance statistic of the second plurality of performance statistics, and performing the statistical aggregation process further by including only performance statistics of the second plurality of performance statistics for which a corresponding statistic identifier matches a statistic identifier of the second plurality of statistic identifiers.

[Item-8] The method of any of Item-1-Item-7, further including updating a version level of the performance management schema of the PM microservice, receiving, from the first client microservice of the CNF, the first table identifier, the first plurality of statistic identifiers, and a second plurality of performance statistics, wherein each statistic identifier of the second plurality of statistic identifiers corresponds to the first table identifier and to a performance statistic of the first plurality of performance statistics, and performing the statistical aggregation process further by obtaining an updated second table identifier and a corresponding updated second plurality of statistic identifiers defined in the updated version level of the performance management schema of the PM microservice, and including only performance statistics of the second plurality of performance statistics for which a corresponding statistic identifier matches a statistic identifier of the updated second plurality of statistic identifiers.

[Item-9] The method of any of Item-1-Item-8, further including receiving, from the first client microservice of the CNF, the first table identifier, a third plurality of statistic identifiers different from the first plurality of statistic identifiers, and a second plurality of performance statistics, wherein each statistic identifier of the third plurality of statistic identifiers corresponds to the first table identifier and to a performance statistic of the second plurality of performance statistics, and performing the statistical aggregation process further by including only performance statistics of the second plurality of performance statistics for which a corresponding statistic identifier matches a statistic identifier of the second plurality of statistic identifiers.

[Item-10] A method includes using a microservice of a CNF to obtain a first table identifier and a first plurality of statistic identifiers defined in a performance management schema of the microservice, retrieve, from a first performance statistics table corresponding to the first table identifier, a first plurality of performance statistics, wherein each performance statistic of the first plurality of performance statistics corresponds to a statistic identifier of the first plurality of statistic identifiers, and send each of the first table identifier, the first plurality of statistic identifiers, and the first plurality of performance statistics to a PM microservice of the CNF.

[Item-11] The method of Item-10, wherein retrieving the first plurality of performance statistics includes obtaining a first status marker corresponding to a first statistic identifier and performance statistic, and excluding the first statistic identifier from the first plurality of statistic identifiers and the first performance statistic from the first plurality of performance statistics in response to a first indication of the first status marker.

[Item-12] The method of Item-11, wherein retrieving the first plurality of performance statistics further includes obtaining a second status marker corresponding to a second statistic identifier and performance statistic, and including the second statistic identifier in the first plurality of statistic identifiers and the second performance statistic in the first plurality of performance statistics in response to a second indication of the second status marker.

[Item-13] The method of any of Item-10-Item-12, wherein sending each of the first table identifier, the first plurality of statistic identifiers, and the first plurality of performance statistics to the PM microservice includes sending an RPC message.

[Item-14] The method of any of Item-10-Item-13, further including using the microservice to update a version level of the performance management schema of the microservice, obtain a second plurality of statistic identifiers different from the first plurality of statistic identifiers and defined in the updated version level of the performance management schema of the microservice, retrieve, from the first performance statistics table, a second plurality of performance statistics, wherein each performance statistic of the second plurality of performance statistics corresponds to a statistic identifier of the second plurality of statistic identifiers; and send each of the first table identifier, the second plurality of statistic identifiers, and the second plurality of performance statistics to the PM microservice.

[Item-15] A method includes outputting, from a first client microservice of a CNF, a first table identifier, a first plurality of statistic identifiers, and a first plurality of performance statistics, wherein the first table identifier corresponds to a first performance statistics table of the first client microservice, each statistic identifier of the first plurality of statistic identifiers corresponds to the first table identifier and to a performance statistic of the first plurality of performance statistics, and the first table identifier and the first plurality of statistic identifiers are defined in a first performance management schema of the first client microservice, receiving the first table identifier, first plurality of statistic identifiers, and first plurality of performance statistics at a PM microservice of the CNF, and performing, using the PM microservice, a statistical aggregation process on the first plurality of performance statistics by including only performance statistics of the first plurality of performance statistics for which a corresponding statistic identifier matches a statistic identifier of a second plurality of statistic identifiers defined in a second performance management schema of the PM microservice.

[Item-16] The method of Item-15, further including receiving at the PM microservice, from a second client microservice of the CNF, a second table identifier, a third plurality of statistic identifiers, and a second plurality of performance statistics, wherein the second table identifier corresponds to a first performance statistics table of the second client microservice and each statistic identifier of the third plurality of statistic identifiers corresponds to the second table identifier and to a performance statistic of the second plurality of performance statistics, and performing the statistical aggregation process on the second plurality of performance statistics by including only performance statistics of the second plurality of performance statistics for which a corresponding statistic identifier matches a statistic identifier of the second plurality of statistic identifiers.

[Item-17] The method of Item-16, wherein performing the statistical aggregation process includes sending statistical summary information to one or more OSS, and the statistical summary information includes each of the included performance statistics of the first plurality of performance statistics and the included performance statistics of the second plurality of performance statistics.

[Item-18] The method of Item-17, wherein the statistical summary information further includes a performance statistic corresponding to a statistic identifier of the second plurality of statistic identifiers and not included in one of the first plurality of performance statistics or the second plurality of performance statistics.

[Item-19] The method of any of Item-15-Item-18, further including updating a version level of the first performance management schema of the first client microservice, and outputting, from the first client microservice, the first table identifier, a third plurality of statistic identifiers, and a third plurality of performance statistics defined in the updated first performance management schema of the first client microservice, wherein each statistic identifier of the third plurality of statistic identifiers corresponds to a performance statistic of the second plurality of performance statistics.

[Item-20] The method of any of Item-15-Item-19, further including updating a version level of the second performance management schema of the PM microservice, and further performing the statistical aggregation process on the first plurality of performance statistics by including each performance statistic of the first plurality of performance statistics for which a corresponding statistic identifier matches a statistic identifier of a third plurality of statistic identifiers defined in the updated second performance management schema of the PM microservice.

The foregoing outlines features of several embodiments so that those skilled in the art better understand the aspects of the present disclosure. Those skilled in the art appreciate that they readily use the present disclosure as a basis for designing or modifying other processes and structures for carrying out the same purposes and/or achieving the same advantages of the embodiments introduced herein. Those skilled in the art also realize that such equivalent constructions do not depart from the spirit and scope of the present disclosure, and that they make various changes, substitutions, and alterations herein without departing from the spirit and scope of the present disclosure.

What is claimed is:

1. A method comprising:
receiving, from a first client microservice of a cloud-native network function (CNF), a first table identifier, a first plurality of statistic identifiers, and a first plurality of performance statistics, wherein
the first table identifier corresponds to a first performance statistics table of the first client microservice, and
each statistic identifier of the first plurality of statistic identifiers corresponds to the first table identifier and to a performance statistic of the first plurality of performance statistics; and
using a performance management (PM) microservice of the CNF to perform a statistical aggregation process by:
obtaining a second table identifier and a corresponding second plurality of statistic identifiers defined in a performance management schema of the PM microservice; and
including only performance statistics of the first plurality of performance statistics for which a corresponding statistic identifier matches a statistic identifier of the second plurality of statistic identifiers.

2. The method of claim 1, wherein
the performing the statistical aggregation process comprises assigning a default value to a performance statistic corresponding to a statistic identifier of the second plurality of statistic identifiers that is not included in the first plurality of statistic identifiers.

3. The method of claim 1, wherein
the performance statistics of the first plurality of performance statistics matching the corresponding statistic identifier of the second plurality of statistic identifiers is based on a status marker of the corresponding statistic identifier.

4. The method of claim 1, wherein
the performing the statistical aggregation process comprises sending statistical summary information to a northbound management system (NMS), and
the statistical summary information comprises each of the included performance statistics of the first plurality of performance statistics.

5. The method of claim 1, wherein
the CNF comprises a node of a radio access network (RAN), and
the first plurality of performance statistics comprises one or more of a throughput number, a number of active cell users, a cell uptime, or a cell downtime.

6. The method of claim 1, further comprising:
receiving, from the first client microservice, a third table identifier, a third plurality of statistic identifiers, and a second plurality of performance statistics, wherein
the third table identifier corresponds to a second performance statistics table of the first client microservice, and
each statistic identifier of the third plurality of statistic identifiers corresponds to the third table identifier and to a performance statistic of the second plurality of performance statistics; and
performing the statistical aggregation process further by:
obtaining a fourth table identifier and a corresponding fourth plurality of statistic identifiers defined in the performance management schema of the PM microservice; and
including only performance statistics of the second plurality of performance statistics for which a corresponding statistic identifier matches a statistic identifier of the fourth plurality of statistic identifiers.

7. The method of claim 1, further comprising:
receiving, from a second client microservice of the CNF, a third table identifier, a third plurality of statistic identifiers, and a second plurality of performance statistics, wherein
the second table identifier corresponds to a first performance statistics table of the second client microservice, and
each statistic identifier of the third plurality of statistic identifiers corresponds to the third table identifier and to a performance statistic of the second plurality of performance statistics; and
performing the statistical aggregation process further by including only performance statistics of the second plurality of performance statistics for which a corresponding statistic identifier matches a statistic identifier of the second plurality of statistic identifiers.

8. The method of claim 1, further comprising:
updating a version level of the performance management schema of the PM microservice;
receiving, from the first client microservice of the CNF, the first table identifier, the first plurality of statistic identifiers, and a second plurality of performance statistics,
wherein each statistic identifier of the second plurality of statistic identifiers corresponds to the first table identifier and to a performance statistic of the first plurality of performance statistics; and
performing the statistical aggregation process further by:
obtaining an updated second table identifier and a corresponding updated second plurality of statistic identifiers defined in the updated version level of the performance management schema of the PM microservice; and
including only performance statistics of the second plurality of performance statistics for which a corresponding statistic identifier matches a statistic identifier of the updated second plurality of statistic identifiers.

9. The method of claim 1, further comprising:
receiving, from the first client microservice of the CNF, the first table identifier, a third plurality of statistic identifiers different from the first plurality of statistic identifiers, and a second plurality of performance statistics,
wherein each statistic identifier of the third plurality of statistic identifiers corresponds to the first table identifier and to a performance statistic of the second plurality of performance statistics; and
performing the statistical aggregation process further by:
including only performance statistics of the second plurality of performance statistics for which a corresponding statistic identifier matches a statistic identifier of the second plurality of statistic identifiers.

10. A method comprising:
using a microservice of a cloud native network function (CNF) to:
obtain a first table identifier and a first plurality of statistic identifiers defined in a performance management schema of the microservice;
retrieve, from a first performance statistics table corresponding to the first table identifier, a first plurality of performance statistics, wherein each performance statistic of the first plurality of performance statistics corresponds to a statistic identifier of the first plurality of statistic identifiers; and
send each of the first table identifier, the first plurality of statistic identifiers, and the first plurality of performance statistics to a performance management (PM) microservice of the CNF.

11. The method of claim 10, wherein retrieving the first plurality of performance statistics comprises:
obtaining a first status marker corresponding to a first statistic identifier and performance statistic; and
excluding the first statistic identifier from the first plurality of statistic identifiers and the first performance statistic from the first plurality of performance statistics in response to a first indication of the first status marker.

12. The method of claim 11, wherein retrieving the first plurality of performance statistics further comprises:
obtaining a second status marker corresponding to a second statistic identifier and performance statistic; and
including the second statistic identifier in the first plurality of statistic identifiers and the second performance statistic in the first plurality of performance statistics in response to a second indication of the second status marker.

13. The method of claim 10, wherein
sending each of the first table identifier, the first plurality of statistic identifiers, and the first plurality of performance statistics to the PM microservice comprises sending a remote procedure call (RPC) message.

14. The method of claim 10, further comprising using the microservice to:
update a version level of the performance management schema of the microservice;
obtain a second plurality of statistic identifiers different from the first plurality of statistic identifiers and defined in the updated version level of the performance management schema of the microservice;
retrieve, from the first performance statistics table, a second plurality of performance statistics, wherein each performance statistic of the second plurality of performance statistics corresponds to a statistic identifier of the second plurality of statistic identifiers; and
send each of the first table identifier, the second plurality of statistic identifiers, and the second plurality of performance statistics to the PM microservice.

15. A method comprising:
outputting, from a first client microservice of a cloud-native network function (CNF), a first table identifier, a first plurality of statistic identifiers, and a first plurality of performance statistics, wherein
the first table identifier corresponds to a first performance statistics table of the first client microservice,
each statistic identifier of the first plurality of statistic identifiers corresponds to the first table identifier and to a performance statistic of the first plurality of performance statistics, and
the first table identifier and the first plurality of statistic identifiers are defined in a first performance management schema of the first client microservice;
receiving the first table identifier, first plurality of statistic identifiers, and first plurality of performance statistics at a performance management (PM) microservice of the CNF; and
performing, using the PM microservice, a statistical aggregation process on the first plurality of performance statistics by including only performance statistics of the first plurality of performance statistics for which a corresponding statistic identifier matches a statistic identifier of a second plurality of statistic identifiers defined in a second performance management schema of the PM microservice.

16. The method of claim 15, further comprising:
receiving at the PM microservice, from a second client microservice of the CNF, a second table identifier, a third plurality of statistic identifiers, and a second plurality of performance statistics, wherein
the second table identifier corresponds to a first performance statistics table of the second client microservice, and
each statistic identifier of the third plurality of statistic identifiers corresponds to the second table identifier and to a performance statistic of the second plurality of performance statistics; and
performing the statistical aggregation process on the second plurality of performance statistics by including only performance statistics of the second plurality of performance statistics for which a corresponding statistic identifier matches a statistic identifier of the second plurality of statistic identifiers.

17. The method of claim 16, wherein
the performing the statistical aggregation process comprises sending statistical summary information to one or more operational support systems (OSS), and
the statistical summary information comprises each of the included performance statistics of the first plurality of performance statistics and the included performance statistics of the second plurality of performance statistics.

18. The method of claim 17, wherein the statistical summary information further comprises a performance statistic corresponding to a statistic identifier of the second plurality of statistic identifiers and not included in one of the first plurality of performance statistics or the second plurality of performance statistics.

19. The method of claim 15, further comprising:
updating a version level of the first performance management schema of the first client microservice; and
outputting, from the first client microservice, the first table identifier, a third plurality of statistic identifiers, and a second plurality of performance statistics defined in the updated first performance management schema of the first client microservice, wherein each statistic identifier of the third plurality of statistic identifiers corresponds to a performance statistic of the second plurality of performance statistics.

20. The method of claim 15, further comprising:
updating a version level of the second performance management schema of the PM microservice; and
further performing the statistical aggregation process on the first plurality of performance statistics by including each performance statistic of the first plurality of performance statistics for which a corresponding statistic identifier matches a statistic identifier of a third plurality of statistic identifiers defined in the updated second performance management schema of the PM microservice.
